(19) United States
(12) Patent Application Publication
(10) Pub. No.: US 2019/0051302 A1
(43) Pub. Date: Feb. 14, 2019

(54) TECHNOLOGIES FOR CONTEXTUAL NATURAL LANGUAGE GENERATION IN A VEHICLE

(71) Applicant: Intel Corporation, Santa Clara, CA (US)

(72) Inventors: Jesus Gonzalez, Mairena del Aljarafe (ES); Ignacio Alvarez, Portland, OR (US)

(21) Appl. No.: 16/139,131

(22) Filed: Sep. 24, 2018

(51) Int. Cl. G10L 15/22; G10L 15/18; G06K 9/00; G10L 25/90

(52) U.S. Cl. CPC G10L 15/22; G10L 15/1807; G06K 9/00832; G10L 2015/228; G10L 15/1815; G10L 2015/223; G10L 2015/227; G10L 25/90

(57) ABSTRACT

Technologies for contextual natural language generation in a vehicle are disclosed. A natural language generation system may generate responses to passenger input that is based on the passenger state, the vehicle state, and the state of a dialogue manager. Tailoring parameters such as tone, volume, lexicon, etc., may allow for a more positive response from a passenger in the vehicle, increasing the trust and faith the passenger may have in the vehicle's computing system.

### BACKGROUND

Natural language interaction with compute devices is becoming commonplace. A user of a cell phone may instruct the cell phone to perform an operation, such as setting a reminder or adding a calendar event. The cell phone may perform the requested action and provide a natural language response to the user indicating the action that it took.

Natural language interaction can also extend to other areas, such as interaction between a vehicle and a passenger in the vehicle. In addition to controlling “infotainment” such as playing music, natural language interaction may also be used to control an autonomous or semi-autonomous vehicle. A good natural language interaction system may assist in establishing a level of confidence or trust in a vehicle, which may be particularly important in making users of autonomous vehicles comfortable in the capabilities of the vehicle.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of a vehicle with a compute device for contextual natural language generation.

FIG. 2 is a simplified block diagram of at least one embodiment of the compute device of FIG. 1;

FIG. 3 is a block diagram of at least one embodiment of an environment that may be established by the compute device of FIG. 2;

FIGS. 4-6 are a simplified flow diagram of at least one embodiment of a method for contextual natural language generation that may be executed by the compute device of FIG. 2; and

FIG. 7 is a simplified flow diagram of at least one embodiment of a method for employing a partially observable Markov decision process that may be executed by the compute device of FIG. 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

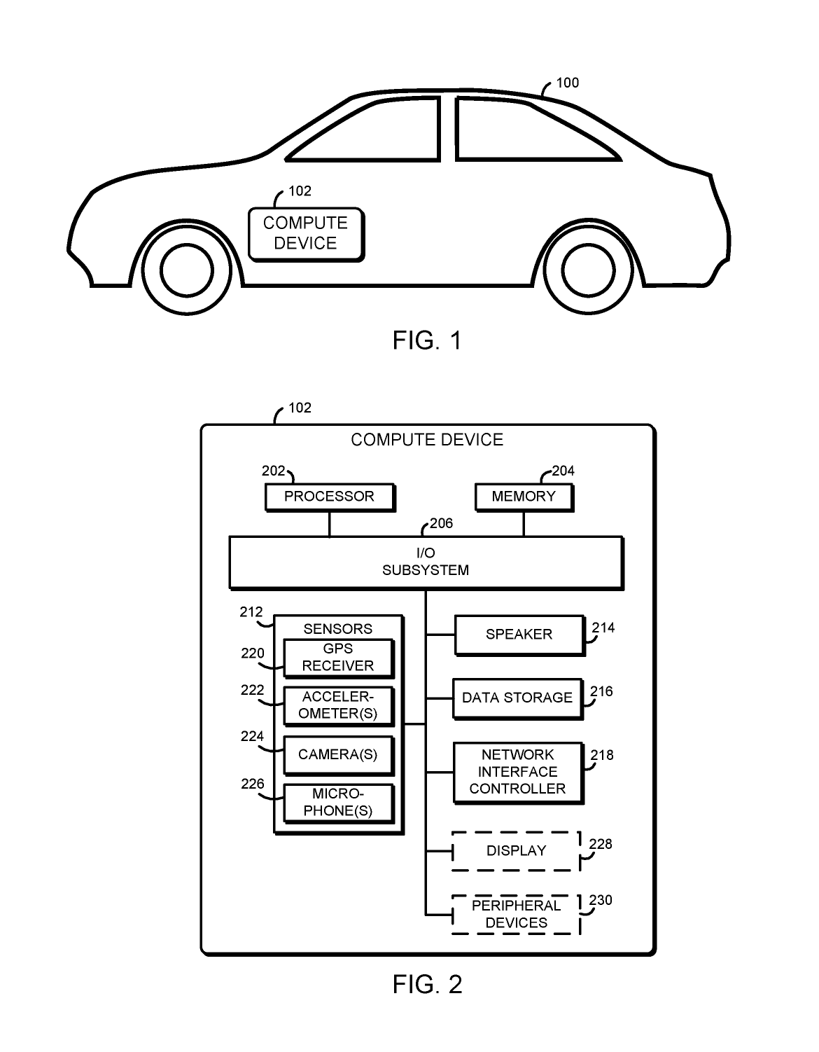

Referring now to FIG. 1, an illustrative vehicle 100 includes a compute device 102. In use, the compute device 102 operates a dialogue manager for interacting with a passenger of the vehicle 100. The compute device 102 may receive an input from a passenger of the vehicle 100, such as instructions to provide directions to a particular location or to play music. The compute device 102 may perform the desired action and prepare an output response to the passenger. In preparing a response, the compute device 102 may determine a passenger state, determine the state of the vehicle 100, and determine a state of the dialogue manager. For example, the compute device 102 may determine a mood of a passenger by, e.g., analyzing speech data of the passenger or by accessing a user profile associated with the passenger, and the compute device 102 may determine a state of the vehicle 100, such as whether the driver of the vehicle 100 is or soon will perform some action such as braking or changing lanes. The compute device 102 may then generate a natural language response to the passenger's input based on the state of the passenger, vehicle 100, and dialogue manager. For example, if the user input is provided by the passenger speaking, the compute device 102 may generate a natural language response that matches the tempo, volume, and verbosity of the passenger's input.

The vehicle 100 may be any suitable vehicle that has a compute device 102 capable of performing the functions described herein. In some embodiments, the vehicle 100 may be a completely or partially autonomous vehicle, such as one that is able to navigate some or all of the route to a destination without manual control by a driver.

Referring now to FIG. 2, the compute device 102 may be embodied as any type of compute device capable of performing the functions described herein. For example, the compute device 102 may be embodied as or otherwise be included in, without limitation, an embedded computing system, a server computer, a System-on-a-Chip (SoC), a multiprocessor system, a processor-based system, a consumer electronic device, a smartphone, a cellular phone, a desktop computer, a tablet computer, a notebook computer, a laptop computer, a network device, a networked computer, a wearable computer, a handset, a messaging device, a camera device, and/or any other computing device. The illustrative compute device 102 includes the processor 202, a memory 204, an input/output (I/O) subsystem 206, sensors 212, a speaker 214, data storage 216, and a network interface controller 218. In some embodiments, one or more of the illustrative components of the compute device 102 may be incorporated in, or otherwise form a portion of, another component. For example, the memory 204, or portions thereof, may be incorporated in the processor 202 in some embodiments.

The processor 202 may be embodied as any type of processor capable of performing the functions described herein. For example, the processor 202 may be embodied as a single or multi-core processor(s), a single or multi-socket processor, a digital signal processor, a graphics processor, a microcontroller, or other processor or processing/controlling circuit. Similarly, the memory 204 may be embodied as any type of volatile or non-volatile memory or data storage capable of performing the functions described herein. In operation, the memory 204 may store various data and software used during operation of the compute device 102 such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the compute device 102. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 206 may form a portion of a system-on-a-chip (SoC) and be incorporated, along with the processor 202, the memory 204, and other components of the compute device 102 on a single integrated circuit chip.

The sensors 212 may include any number or type of sensor, such as a GPS receiver 220, one or more accelerometers 222, one or more cameras 224, and one or more microphones 226. The GPS receiver 220 may be configured to receive information from GPS satellites, other satellites, or terrestrial data sources that can be used to determine a position of the vehicle 100. The accelerometers 222 may be configured to sense a linear or angular acceleration of the vehicle 100 in one or more axes, such as x-axis, y-axis, z-axis, yaw axis, pitch axis, and roll axis. The cameras 224 may include cameras that capture images of the interior of the car, including images of passengers in the car, and/or images of the exterior of the car, such as the roadway, other vehicles, pedestrians, etc. The microphones 226 may be configured to capture speech data from a passenger in the vehicle 100 and/or capture other sound data from inside or outside the vehicle 100. Additional sensors 212 may detect operating conditions of the vehicle 100, such as an amount of acceleration, an amount of breaking, an orientation of the steering wheel, use of a turn signal of the vehicle 100, etc. In some embodiments, the sensors 212 may include sensors to sense biometrics of a passenger, such as skin conductance, heart rate, etc. In the illustrative embodiment, the sensors 212 may be embedded in or otherwise form a part of the vehicle 100. For example, a dashboard of the vehicle 100 may include a camera 224 and/or a microphone 226.

The speaker 214 may be any type of speaker 214 capable of creating sound inside the vehicle 100. The speaker 214 may play various types of sounds, such as by outputting a natural language response from the compute device 102 or by playing music or other sounds.

The data storage 216 may be embodied as any type of device or devices configured for the short-term or long-term storage of data. For example, the data storage 216 may include any one or more memory devices and circuits, memory cards, hard disk drives, solid-state drives, or other data storage devices.

The network interface controller 218 may be embodied as any type of interface capable of interfacing the compute device 102 with other compute devices, such as over an antenna. Additionally or alternatively, in some embodiments, the network interface controller 218 may be capable of interfacing with any appropriate cable type, such as an electrical cable or an optical cable. The network interface controller 218 may be configured to use any one or more communication technology and associated protocols (e.g., Ethernet, Bluetooth®, Wi-Fi®, WiMAX, near field communication (NFC), etc.). The network interface controller 218 may be located on silicon separate from the processor 202, or the network interface controller 218 may be included in a multi-chip package with the processor 202, or even on the same die as the processor 202. The network interface controller 218 may be embodied as one or more add-in-boards, daughtercards, network interface cards, controller chips, chipsets, specialized components such as a field programmable gate array (FPGA) or application specific integrated circuit (ASIC), or other devices that may be used by the compute device 102 to connect with another compute device. In some embodiments, network interface controller 218 may be embodied as part of a system-on-a-chip (SoC) that includes one or more processors, or included on a multichip package that also contains one or more processors. In some embodiments, the network interface controller 218 may include a local processor (not shown) and/or a local memory (not shown) that are both local to the network interface controller 218. In such embodiments, the local processor of the network interface controller 218 may be capable of performing one or more of the functions of the processor 202 described herein. Additionally or alternatively, in such embodiments, the local memory of the network interface controller 218 may be integrated into one or more components of the compute device 102 at the board level, socket level, chip level, and/or other levels.

In some embodiments, the compute device 102 may include other or additional components, such as those commonly found in a compute device. For example, the compute device 102 may also have a display 228 and/or peripheral devices 230. The peripheral devices 230 may include a keyboard, a mouse, etc. The display 228 may be embodied as any type of display on which information may be displayed to a user of the compute device 102, such as a touchscreen display, a liquid crystal display (LCD), a light emitting diode (LED) display, a cathode ray tube (CRT) display, a plasma display, an image projector (e.g., 2D or 3D), a laser projector, a heads-up display, and/or other display technology. In some embodiments, the display 228 may be embedded in or otherwise form a part of the vehicle 100.

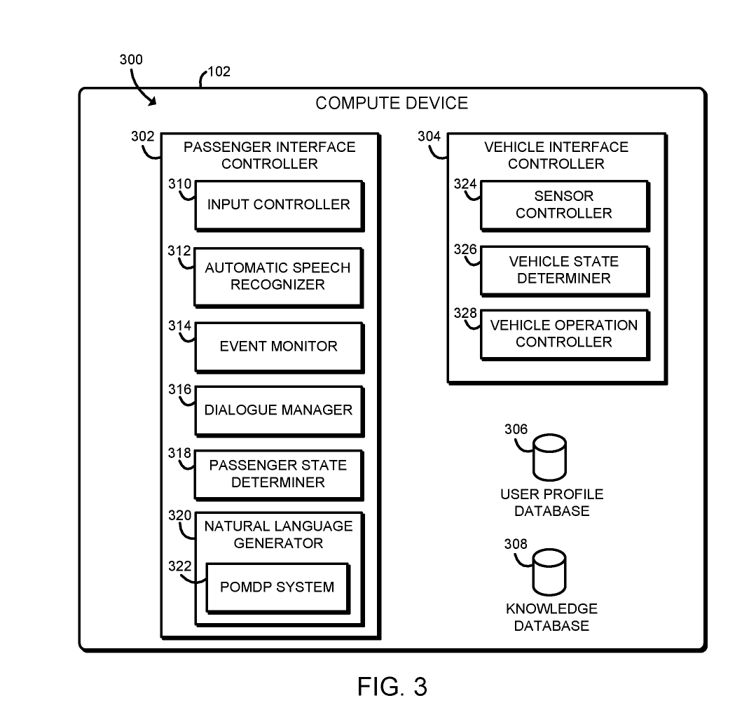

Referring now to FIG. 3, in an illustrative embodiment, the compute device 102 establishes an environment 300 during operation. The illustrative environment 300 includes a passenger interface controller 302, vehicle interface controller 304, a user profile database 306, and a knowledge database 308. The various components of the environment 300 may be embodied as hardware, software, firmware, or a combination thereof. For example, the various components of the environment 300 may form a portion of, or otherwise be established by, the processor 202 or other hardware components of the compute device 102. As such, in some embodiments, one or more of the components of the environment 300 may be embodied as circuitry or collection of electrical devices (e.g., passenger interface circuitry 302, vehicle interface circuitry 304, etc.). It should be appreciated that, in such embodiments, one or more of the circuits (e.g., the passenger interface circuitry 302, the vehicle interface circuitry 304, etc.) may form a portion of one or more of the processor 202, the memory 204, the I/O subsystem 206, the network interface controller 210, the data storage 216, an application specific integrated circuit (ASIC), a programmable circuit such as a field-programmable gate array (FPGA), and/or other components of the compute device 102. For example, the passenger interface circuitry 302 may be embodied as the processor 202 and associated instructions stored on the data storage 216 and/or the memory 204, which may be executed by the processor 202. Additionally, in some embodiments, one or more of the illustrative components may form a portion of another component and/or one or more of the illustrative components may be independent of one another. Further, in some embodiments, one or more of the components of the environment 300 may be embodied as virtualized hardware components or emulated architecture, which may be established and maintained by the processor 202 or other components of the compute device 102. It should be appreciated that some of the functionality of one or more of the components of the environment 300 may require a hardware implementation, in which case embodiments of components which implement such functionality will be embodied at least partially as hardware.

The passenger interface controller 302, which may be embodied as hardware, firmware, software, virtualized hardware, emulated architecture, and/or a combination thereof as discussed above, is configured to interact with the passengers of the vehicle 100. It should be appreciated that, as used herein, a passenger includes anyone inside the vehicle 100, including a driver of the vehicle 100. The passenger interface controller 302 includes an input controller 310, an automatic speech recognizer 312, an event monitor 314, a dialogue manager 316, a passenger state determiner 318, a dialogue manager state determiner 320, and a natural language generator 322.

The input controller 310 is configured to accept input from a passenger in the vehicle 100. In the illustrative embodiment, a passenger may provide input by speaking, which can be captured by a microphone 226 and passed to the input controller 310. Additionally or alternatively, in some embodiments, the input controller 310 may receive input from a user in a number of other ways, such as pressing buttons, touch a touch-screen display, etc. For example, in some embodiments, a user may press a button on the steering wheel to initiate an interaction with the dialogue manager 316. The input provided to the input controller 310 may provide an indication of a desired action, such as changing a navigation destination, changing a music setting, changing a system preference, providing an indication of a choice in a menu of a dialogue interface, placing a phone call, synchronizing with a phone such as through Bluetooth®, changing a climate setting, changing a setting relating to the instrument cluster, etc. In some embodiments, the input may relate to operation of the vehicle, such as instructing the vehicle 100 to change speed or change lanes. After receiving the input, the input controller 310 may provide it to the dialogue manager 316 or any other element of the compute device 102.

The automatic speech recognizer 312 is configured to automatically recognize speech data that the input controller 302 collects from a user. The automatic speech recognizer 312 may transcribe the speech data to text. In the illustrative embodiment, the automatic speech recognizer 312 may also analyze the speech data for prosody parameters such as tempo, pitch, and volume and for linguistic parameters such as register, lexicon, and verbosity.

The event monitor 314 is configured to monitor events that may be relevant to the passenger, dialogue manager 316, or other aspects of the system. For example, a passenger may have an appointment on their calendar coming up that they might miss if they do not change their destination. As another example, the event monitor 314 may receive an indication that the traffic has changed on part of the current route, and the compute device 102 may then present that change to the user.

The dialogue manager 316 is configured to control the interactions between the compute device 102 and the passengers in the vehicle 100. When the compute device 102 requires an input from a passenger, the dialogue manager 316 may presents a prompt to the user, such as on a display 228 or with use of a speaker 214, and wait for input from a passenger. After receiving an input from the passenger, the dialogue manager 316 may perform an action, which may include updating or transitioning the state of the dialogue manager 316. In the illustrative embodiment, the dialogue manager 316 may initialize upon the vehicle 100 turning on or upon another event, such as a user entering a vehicle 100. In some embodiments, the dialogue manager 316 may access a user profile database 306 to access and load a profile associated with a passenger in the vehicle 100. It should be appreciated that, in some embodiments, the dialogue manager 316 may initiate communication with a passenger or may take action without any input from a passenger. For example, if there is an update in traffic, the dialogue manager 316 may ask the user if he wants to change the current route or the dialogue manager 316 may change the current route and notify the user accordingly.

As part of determining an appropriate action to take in response to a user input, the dialogue manager 316 may access various knowledge sources, such as events from the event monitor 314, knowledge from the knowledge database 308, information relating to a passenger such as name and address, information relating to an owner of the vehicle 100, environmental information such as available parking nearby, state of nearby traffic, etc.

After taking an action, the dialogue manager 316 is configured to pass parameters to the natural language generator 320 to provide an output to the passenger. As discussed below in more detail in regard to the natural language generator 320, the dialogue manager 316 does not necessarily pass along a specific message or sentence for the natural language generator 320 to generate.

The passenger state determiner 318 is configured to determine the state of the passenger. The state of the passenger may include any information relating to the passenger, such as the identity of the passenger, an emotional state of the passenger, current, recent, or future tasks of the passenger, etc. The passenger state determiner 318 may determine the state of the passenger in any suitable manner, such as by performing facial recognition or voice recognition to determine an identity of a passenger. The passenger state determiner 318 may determine an emotional state of a passenger by performing image analysis on images of the passenger or voice analysis on speech data of the passenger. For example, the passenger state determiner 318 may determine that a user is tired if he has his eyes closed. In some embodiments, the passenger state determiner 318 may begin with a default state for a passenger. The default state may be the same for every passenger or the passenger state determiner 318 may apply a default state for a passenger that may be learned over time, such as with use of a machine learning algorithm over many trips with the passenger.

The natural language generator 320 is configured to generate a natural language response or output to a passenger of the vehicle 100. Based on the action taken by the dialogue manager 316, the natural language generator 320 generates a message to be provided to the passenger to explain the action taken, provide a confirmation, ask for a clarification, etc. The natural language generator 320 is configured to control both how the response is spoken as well as the words of the response itself. The natural language generator 320 may generate a response based on several parameters, such as prosodic parameters and linguistic parameters. The prosodic parameters may indicate aspects of a desired prosody, such as tempo, pitch, and volume. The linguistic parameters may indicate aspects of desired linguistic features of the response, such as register, lexicon, and verbosity. The natural language generator 320 may choose to apply parameters that are appropriate for a particular situation. In some embodiments, the natural language generator 320 may mimic prosodic or linguistic parameters of the speech data of the passenger and/or may mimic the slang, vocabulary level, etc. of the passenger. The natural language generator 320 may access user preference parameters that may be part of a user profile and may indicate preferences such as gender of the generated voice or speed of the generated voice.

As some example use cases, consider the following scenarios. For example, in one embodiment, if the compute device 102 determines that a passenger named John gets into the vehicle 100 after a late night at work and further determines that the passenger is tired, the response to user input of “Take me home” may be “OK John, now relax. I'm taking you home.” Such a response may be spoken with a slow tempo, an informal tone, a pitch of relief, and medium volume. As another example, if it is raining outside and the user input is “Wow, I'm wet! Take me home!,” and the compute device 102 determines that the user is tired, the natural language generator 320 may generate a response with a fast tempo, an informal tone, an energetic pitch, and high volume. As a third example, a passenger who just started driving from home and realized he forgot something might say, “Oh no, take me home!” The natural language generator 320 may generate a response of “OK, going back home!,” with a fast temp, informal tone, neutral pitch, and high volume. As yet another example, a vehicle 100 that is an automated taxi may wait at the airport for a passenger. A passenger may get in the vehicle 100, and the compute device 100 may recognize the passenger as a businessman who is returning from a trip. The passenger may say, “Take me home, please.” The natural language generator 320 may generate a response of “Yes, sir,” with a medium temp, formal tone, neutral pitch, and medium volume.

The natural language generator 320 may employ any system to determine suitable parameters, such as a rule-based engine or a machine-learning-based system. The natural language generator 320 may employ an imitation-learning approach or a reinforcement-learning approach. In some embodiments, the natural language generator 320 may use a “Wizard of Oz” to train, in which a live person is generating responses for the natural language generator 320 that the natural language generator 320 uses to train itself for future interactions without the passenger knowing that there is a live person generating the responses. As part of a learning process, the natural language generator 320 may monitor the passenger for feedback. For example, the natural language generator 320 may focus on emotional states of frustration and an overall mood of the passenger has in response to output from the natural language generator 320.

In the illustrative embodiment, the natural language generator 320 may employ a partially-observable Markov decision process (POMDP). The POMDP model may employ the tuple <S, A(s), T(s,a), U(s,a), Ω, O>, where S is the state space, A is the action space, T is the transition function between space, U is the reward function, W is the observation that the natural language generation agent can receive, and O is the observation function that maps action aₛ^{t} and state sₜ+1 resulting from taking action aₛ^{t} in response to an observation of oₛ^{t}. An observation may include the passenger state, dialogue manager state, and vehicle state. Each of the states may be described by a series of parameters that may be marked as having certain possible values with a certain likelihood. For example, the vehicle state may include a “traffic state” parameter, that may have an estimated likelihood of “none” to be 0, an estimated likelihood of “light” to be 0.72, an estimated likelihood of “medium” to be 0.21, and an estimated likelihood of “heavy” to be 0.07. The reward function may be defined as indicating a positive reward for actions that produce positive or neutral passenger emotional states (such as joy, neutral, or surprise) and negative rewards for actions that produce negative passenger emotional states (such as sadness, disgust, or fear). The POMDB also includes a belief state b, which is an indication of the probability that the system is in a given state.

An action aₛ^{t} indicates the parameters to use for the natural language generation system for a given state at a given time. The parameters may include prosodic parameters such as tempo, tone, pitch, and volume as well as linguistic parameters such as register, verbosity, and lexicon. In some embodiments, the POMDP model may define a relatively small number of “profiles” for natural language generation, where each profile indicates a value for each prosodic and linguistic parameter. For example, the possible profiles might be lively, cooperative, commanding, neutral, shy, and apologetic. The shy profile may use a low tempo, a formal tone, a low pitch, a low volume, a neutral register, a low verbosity, and a low lexicon. The lively profile might use a high tempo, an informal tone, a high pitch, a medium volume, a neutral register, a medium verbosity, and a lexicon mirroring that of the passenger. The use of profiles may significantly reduce the dimensionality of the action aₛ^{t}, reducing the time required to train the system.

At any given iteration, the POMDP may receive an observation oₛ^{t} and a reward for the last action taken, uₐ^{t-1}. After getting the reward, the POMDP updates its belief of each state using the following formula:

bₛ^{t+1}∝O(s^{t+1},a^{t},oₛ^{t})Σₛ_{^{t}}_{∈S}T(s^{t},a^{t},s^{t+1})b^{t}.

The POMDP model can be trained using random actions, and the resulting training will provide weights for the belief state as well as for the policy strategy. The optimization can be made using various algorithms such as t-step value iteration, point-based value iteration, or heuristic search value iteration.

Referring now to the vehicle interface controller 304, which may be embodied as hardware, firmware, software, virtualized hardware, emulated architecture, and/or a combination thereof as discussed above, is configured to interface the compute device 102 with the vehicle 100. The vehicle interface controller 304 includes a sensor controller 324, a vehicle state determiner 326, and a vehicle operation controller 328.

The sensor controller 324 is configured to receive data from sensors 212. In the illustrative embodiment, the sensors 212 may be embedded in or otherwise form a part of the vehicle 100. For example, a dashboard of the vehicle 100 may include a camera 224 and/or a microphone 226. The sensor controller 324 is configured to access the sensors 212 of the vehicle 100 and/or sensors 212 of the compute device 102.

The vehicle state determiner 326 is configured to determine state of the vehicle 100. The state of the vehicle 100 may include information such as the location of the vehicle 100, speed of the vehicle 100, nearby traffic, whether the vehicle 100 is expected to take any action soon such as braking, turning, changing lanes, accelerating, etc.

The vehicle operation controller 328 is configured to control operation of the vehicle. The vehicle operation controller 328 may control aspects of an “infotainment” system, such as by playing music, displaying weather information, showing phone contacts to a passenger, changing climate settings, etc. The vehicle operation controller 328 may also control navigation aspects, such as a current destination, a current route, etc. In some embodiments, such as ones in which the vehicle 100 is completely autonomous or semi-autonomous, the vehicle operation controller 328 may also control aspects related to movement of the vehicle, such as by controlling the steering, acceleration, or braking.

The user profile database 306 may hold profiles of users (e.g. passengers) of the compute device 102. A user profile may include information about a user such as name, address, whether he is the owner of the vehicle 100, calendar events associated with the user, preferences of the user such as gender of the generated voice or speed of the generated voice.

The knowledge database 308 may include any knowledge that may be relevant to operation of the vehicle 100 or compute device 102. In some embodiments, the knowledge database 308 may be embodied as an ontology. The knowledge database 308 may include information such as past traffic patterns, current traffic patterns, events, etc. In some embodiments, the compute device 102 may update the knowledge database 308 by accessing information associated with the user, such as by mining e-mails sent to or by the user.

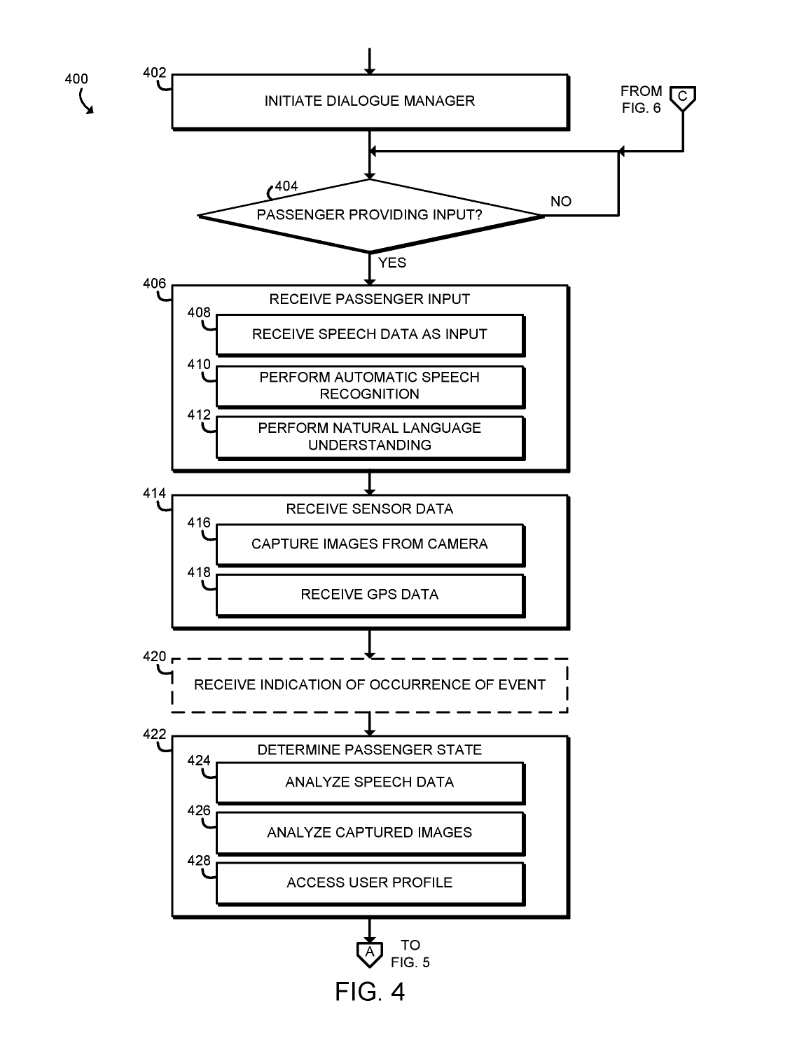

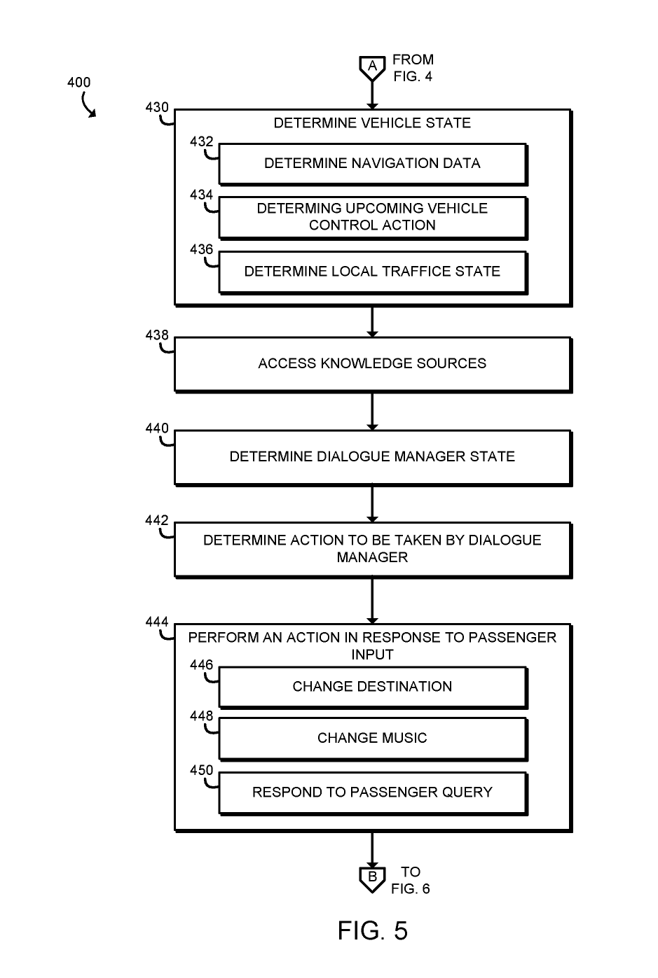

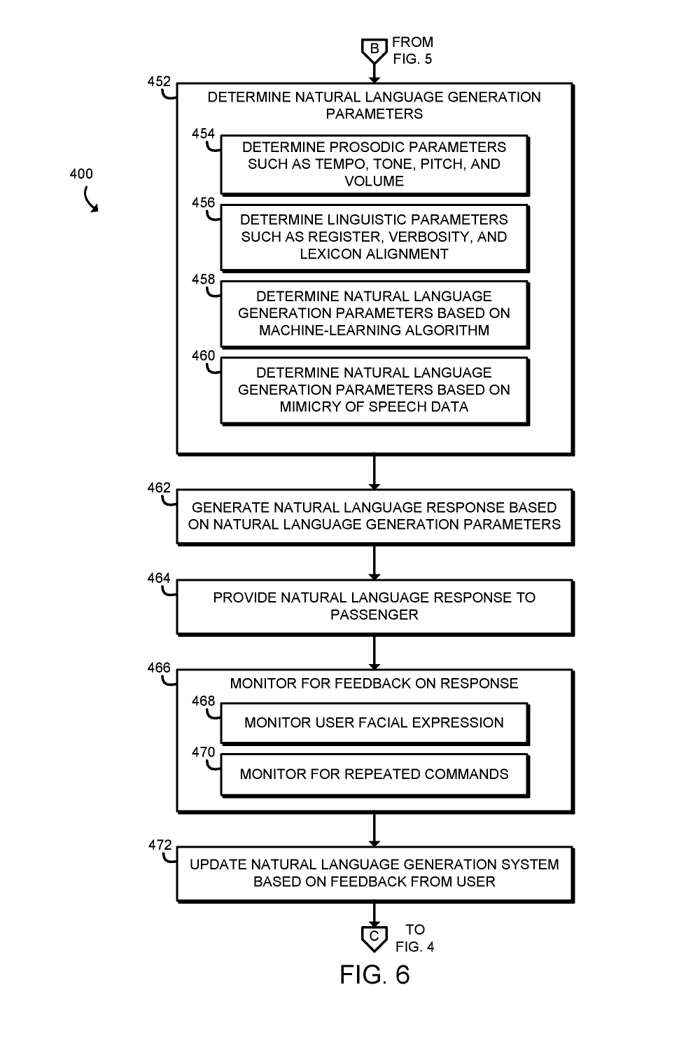

Referring now to FIG. 4, in use, the compute device 102 may execute a method 400 for contextual natural language generation. The method begins in block 402, in which the compute device 102 initiates a dialogue manager. The compute device 102 may initiate the dialogue manager upon the vehicle 100 turning on or upon another event, such as a user entering a vehicle 100. The dialogue manager may begin in a default state. In some embodiments, the dialogue manager 316 may access a user profile database 306 to access and load a profile associated with a passenger in the vehicle 100.

In block 404, if the passenger is not providing input, the method 400 loops back to block 404 to wait for passenger input. It should be appreciated that, in some embodiments, the compute device 102 may initiate communication with a passenger or may take action without any input from a passenger. For example, if there is an update in traffic, the compute device 102 may initiate an interaction such as by asking the user if he wants to change the current route or by changing the current route and notifying the user accordingly. If the passenger is providing input, the method 400 proceeds to block 406.

In block 406, the compute device 102 receives input from a passenger of the vehicle 100. In the illustrative embodiment, the compute device 102 may receive input from a microphone 226 in block 408, in which case the input may be embodied as speech data. The compute device 102 may perform automatic speech recognition on the speech data in block 410 to transcribe the speech data to text. In the illustrative embodiment, the compute device 102 may also analyze the speech data for prosody parameters such as tempo, pitch, and volume and for linguistic parameters such as register, lexicon, and verbosity. The compute device 102 may then perform natural language understanding on the transcribed speech data to determine a semantic interpretation of the speech data. The input provided to the compute device 102 may provide an indication of a desired action, such as changing a navigation destination, changing a music setting, changing a system preference, providing an indication of a choice in a menu of a dialogue interface, placing a phone call, synchronizing with a phone such as through Bluetooth®, changing a climate setting, changing a setting relating to the instrument cluster, etc. In some embodiments, the input may relate to operation of the vehicle, such as instructing the vehicle 100 to change speed or change lanes.

In block 414, the compute device 102 may receive sensor data. In the illustrative embodiment, the compute device 102 may capture images from the camera 224 in block 416 and may receive GPS data from a GPS receiver 220 in block 418. In some embodiments, the compute device 102 may receive sensor data from other sensors, such as accelerometers 222 and/or microphones 226.

In block 420, in some embodiments, the compute device 102 may receive an indication of an occurrence of an event. For example, a passenger may have an appointment on their calendar coming up that they might miss if they do not change their destination. As another example, the compute device 102 may receive an indication that the traffic has changed on part of the current route.

In block 422, the compute device 102 may determine a passenger state. The state of the passenger may include any information relating to the passenger, such as the identity of the passenger, an emotional state of the passenger, current, recent, or future tasks of the passenger, etc. The compute device 102 may determine the state of the passenger in any suitable manner. For example, the compute device 102 may analyze speech data in block 424 to, e.g., identify a passenger or to determine an emotional state of the passenger. The compute device 102 may also analyze captured images in block 426 to identify a passenger or to determine an emotional state of the passenger. For example, the compute device 102 may determine that a user is tired if he has his eyes closed. The compute device 102 may also access a user profile associated with the identified passenger in block 428. The user profile may indicate parameters that can be used to interpret input from the sensors 212 in order to determine a passenger state.

Referring now to FIG. 5, in block 430, the compute device 102 determines a vehicle state. The compute device 102 may determine the state of the vehicle by determining current navigation data in block 432, such as by determining a current destination and/or a current route. The compute device 102 may also determine an upcoming vehicle control action, such as a lane change, braking, acceleration, turning, etc., in block 434. The compute device 102 may also determine the local traffic state in block 436. The state of the vehicle 100 may also include information such as the location of the vehicle 100, the speed of the vehicle 100, etc.

In block 438, the compute device 102 may access knowledge sources, such as events from the event monitor 314, knowledge from the knowledge database 308, information relating to a passenger such as name and address, information relating to an owner of the vehicle 100, environmental information such as available parking nearby, state of nearby traffic, etc. The knowledge database 308 may include any knowledge that may be relevant to operation of the vehicle 100 or compute device 102. In some embodiments, the knowledge database 308 may be embodied as an ontology. The knowledge database 308 may include information such as past traffic patterns, current traffic patterns, events, etc. In some embodiments, the compute device 102 may update the knowledge database 308 by accessing information associated with the user, such as by mining e-mails sent to or by the user.

In block 440, the compute device 102 determines a dialogue manager state. The state of the dialogue manager indicates the context of the dialogue manager, i.e., a question that the dialogue manager recently asked, the state of a menu system displayed to the user, etc. In the illustrative embodiment, the dialogue manager state may represent or indicate an expected user intent, and the main purpose of determining the dialogue manager state may be to determine what information is needed to be extracted in the input from the user.

In block 442, the compute device 102 determines an action to be taken by the dialogue manager. The action may be to implement a desired action as indicated by the user input, such as changing a navigation destination, responding to a user query, changing a music setting, changing a system preference, providing an indication of a choice in a menu of a dialogue interface, placing a phone call, synchronizing with a phone such as through Bluetooth®, changing a climate setting, changing a setting relating to the instrument cluster, etc. In some embodiments, the desired action may relate to operation of the vehicle, such as instructing the vehicle 100 to change speed or change lanes.

In block 444, the compute device 102 performs the action indicated by the dialogue manager. For example, the compute device 102 may change the current navigation destination in block 446 or change the current music in block 448. The compute device 102 may also respond to a passenger query in block 450, such as responding to question of how much longer to get to the destination.

Referring now to FIG. 6, in block 452, the compute device 102 determines natural language generation parameters. In the illustrative embodiment, the compute device 102 determines the natural language parameters based on the passenger state, the dialogue manager state, and the vehicle state. The compute device 102 may determine the parameters based on various factors of the passenger state, such as a user profile, an emotional state of a passenger, current, recent, or future tasks of the passenger, etc. The compute device 102 may also determine the parameters based on various factors of the vehicle state, such as the location of the vehicle 100, speed of the vehicle 100, nearby traffic, whether the vehicle 100 is expected to take any action soon such as braking, turning, changing lanes, accelerating, etc. The compute device 102 may determine the parameters further based on various factors of the dialogue manager state, such as an indication of the context of the dialogue manager, i.e., a question that the dialogue manager recently asked, the state of a menu system displayed to the user, etc. In the illustrative embodiment, the dialogue manager state may represent or indicate an expected user intent, and the compute device 102 may generate natural language parameters based on that expected user intent.

As part of determining the natural language generation parameters, the compute device 102 may generate prosodic parameters in block 454. The prosodic parameters may indicate aspects of a desired prosody, such as tempo, pitch, and volume. The compute device 102 may also generate linguistic parameters in block 456. The linguistic parameters may indicate aspects of desired linguistic features of the response, such as register, lexicon, and verbosity. In some embodiments, the compute device 102 may access user preference parameters that may be part of a user profile and may indicate preferences such as gender of the generated voice or speed of the generated voice.

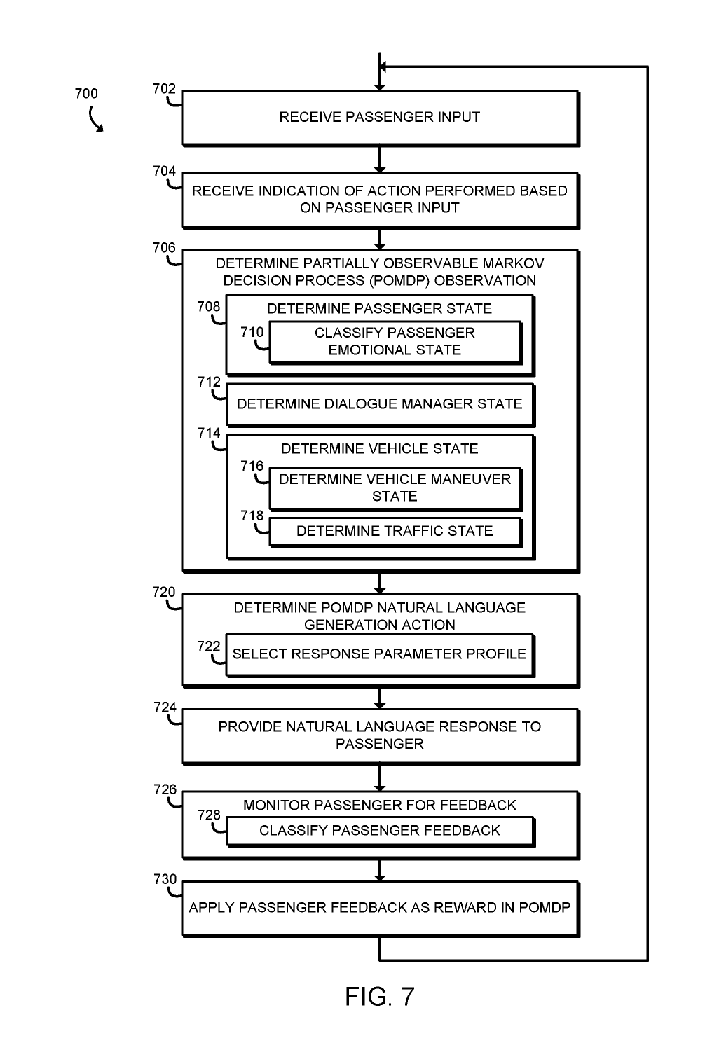

The compute device 102 may generate the natural language parameters in any suitable manner, such as with use of a rule-based engine or a machine-learning-based system in block 458. In some embodiments, the compute device 102 may determine natural language generation parameters based on mimicry of the speech data that the user provided as an input in block 460. The compute device 102 may employ an imitation-learning approach or a reinforcement-learning approach. In some embodiments, the compute device 102 may use a “Wizard of Oz” to train, in which a live person is generating responses for the compute device 102 that the compute device 102 uses to train itself for future interactions without the passenger knowing that there is a live person generating the responses. In the illustrative embodiment, the compute device 102 employ a partially-observable Markov decision process (POMDP), as described in more detail below in regard to FIG. 7.

In block 462, the compute device 102 generates a natural language response based on the determined natural language generation parameters. In block 464, the compute device 102 provides the natural language response to the passenger.

In block 466, the compute device 102 monitors for feedback based on the provided response. The compute device 102 may monitor for feedback in any suitable manner, such as by monitoring a user's facial expression that is done in response to the generated language in block 468. The compute device 102 may also monitor for repeated commands in block 470.

In block 472, the compute device 102 may update the natural language generation system based on the feedback from the user. The method 400 then loops back to block 404 in FIG. 4 to wait for input from the user.

Referring now to FIG. 7, in use, the compute device 102 may execute a method 700 for determining natural language generation parameters with use of a partially-observable Markov decision process (POMDP). It should be appreciated that, in some embodiments, the method 700 may correspond to determining the natural language generation parameters in block 452 of the method 400. It should further be appreciated that a POMDP is one of many possible approaches to generating the natural language parameters. The POMDP model employed in method 700 is described in further detail above in regard to the POMDP system shown in block 322 in FIG. 3. The method 700 may be performed after the POMDP system is trained and initialized, including determining a belief state b, which may be a default belief state upon initialization.

The method 700 begins in block 702, in which the compute device 102 receives a passenger input, as described above in block 404 of the method 400 in FIG. 4. In block 704, the POMDP model receives an indication of an action that is performed based on the passenger input, such as changing a navigation destination.

In block 706, the compute device 102 may determine a POMDP observation. In the illustrative embodiment, a POMDP observation includes a passenger state, a dialogue manager state, and a vehicle state. Each state may be described by a series of parameters that may be marked as having certain possible values with a certain likelihood. For example, the vehicle state may include a “traffic state” parameter, that may have an estimated likelihood of “none” to be 0, an estimated likelihood of “light” to be 0.72, an estimated likelihood of “medium” to be 0.21, and an estimated likelihood of “heavy” to be 0.07.

The compute device 102 may determine the passenger state in block 708. The state of the passenger may include any information relating to the passenger, such as the identity of the passenger, an emotional state of the passenger, current, recent, or future tasks of the passenger, etc. For example, in the illustrative embodiment, the passenger state includes an emotional state that is classified with different confidence levels into a state of “joy,” “neutral,” “sadness,” “surprise,” “disgust,” and “fear.” The emotional state of the user may be determined by classifying the passenger emotional state based on image and/or voice analysis in block 710.

The compute device 102 may determine a dialogue manager state in block 712. The dialogue manager state may include information such as a current task (e.g., navigation), a parameter of that task (such as a particular destination), acts of the user (such as a greeting or a request for information), etc.

The compute device 102 may determine a vehicle state in block 714. The compute device 102 may determine a vehicle maneuver state in block 716, which may indicate whether the vehicle is parked, accelerating, breaking, driving straight, turning right, turning left, merging right, merging left, etc. The compute device 102 may also determine a traffic state in block 718, which may indicated the traffic state as none, light, medium, or heavy.

In block 720, the compute device 102 may determine a POMDP natural language generation action. As described above, an action aₛ^{t} indicates the parameters to use for the natural language generation. The action is chose based on the current state and the transition function with the goal of maximizing the future discounted reward.

In some embodiments, the POMDP model may define a relatively small number of “profiles” for natural language generation, where each profile indicates a value for each prosodic and linguistic parameter. For example, the possible profiles might be lively, cooperative, commanding, neutral, shy, and apologetic. The shy profile may use a low tempo, a formal tone, a low pitch, a low volume, a neutral register, a low verbosity, and a low lexicon. The lively profile might use a high tempo, an informal tone, a high pitch, a medium volume, a neutral register, a medium verbosity, and a lexicon mirroring that of the passenger. As part of determining the POMDP natural language generation action, the compute device 102 may select a response parameter profile in block 722.

In block 724, the compute device 102 provides the natural language response to the passenger that is generated based on the determined parameters. In block 726, the compute device 102 monitors the passenger for feedback. To do so, the compute device 102 may classify the passenger feedback in block 728, such as by performing image analysis to determine an emotional reaction of the passenger.

In block 730, the compute device 102 applies a reward based on the passenger feedback to the POMDP model. In one embodiment, a positive reward may be used for actions that produce positive or neutral passenger emotional states (such as joy, neutral, or surprise) and a negative reward may be used for actions that produce negative passenger emotional states (such as sadness, disgust, or fear). After getting the reward, the POMDP updates its belief of each state using the following formula:

bₛ^{t+1}∝O(s^{t+1},a^{t},oₛ^{t})Σₛ_{^{t}}_{∈S}T(s^{t},a^{t},s^{t+1})b^{t}.

The method 700 then loops back to block 702 to receive input from the user.

It should be appreciated that, although some of the embodiments described above were directed to a compute device 102 a vehicle 100, some or all the techniques described above may be used in other embodiments as well. For example, the compute device 102 may be embodied as a cell phone, and the compute device 102 may control natural language generation parameters as part of the interaction between a user of the cell phone giving voice commands and the compute device 102 responding.

### Examples

Illustrative examples of the devices, systems, and methods disclosed herein are provided below. An embodiment of the devices, systems, and methods may include any one or more, and any combination of, the examples described below.

Example 1 includes a compute device for personalized natural language generation in a vehicle, the compute device comprising passenger interface circuitry to initiate a dialogue manager; receive speech data from a passenger of the vehicle; determine a state of the passenger; and determine a state of the dialogue manager; and vehicle interface circuitry to perform, in response to receipt of the speech data, an action based on the state of the dialogue manager, wherein the passenger interface circuitry is further to determine a plurality of natural language generation parameters based on the state of the passenger; generate, based on the plurality of natural language generation parameters, a natural language response indicative of the action performed in response to receipt of the speech data; and provide the natural language response to the passenger.

Example 2 includes the subject matter of Example 1, and wherein to determine the state of the passenger comprises to analyze the speech data of the passenger; and determine the state of the passenger based on the analysis of the speech data, and wherein to determine the plurality of natural language generation parameters based on the state of the passenger comprises to determine the plurality of natural language generation parameters based on the analysis of the speech data.

Example 3 includes the subject matter of any of Examples 1 and 2, and wherein the vehicle interface circuitry is further to determine a state of the vehicle, wherein to determine the plurality of natural language generation parameters based on the state of the passenger comprises to determine the plurality of natural language generation parameters based on the state of the passenger and based on the state of the vehicle.

Example 4 includes the subject matter of any of Examples 1-3, and wherein to determine the plurality of natural language generation parameters based on the state of the passenger and based on the state of the vehicle comprises to determine the plurality of natural language generation parameters based on the state of the passenger, the state of the vehicle, and the state of the dialogue manager.

Example 5 includes the subject matter of any of Examples 1-4, and wherein to determine the plurality of natural language generation parameters comprises to determine one or more prosodic parameters and one or more linguistic parameters.

Example 6 includes the subject matter of any of Examples 1-5, and wherein to determine one or more prosodic parameters and one or more linguistic parameters comprises to determine a prosodic parameter indicative of a tempo, a pitch, or a volume; and determine a linguistic parameter indicative of a register, a lexicon, or a verbosity.

Example 7 includes the subject matter of any of Examples 1-6, and wherein to determine the plurality of natural language generation parameters comprises to determine the plurality of natural language generation with use of a machine-learning-based algorithm.

Example 8 includes the subject matter of any of Examples 1-7, and wherein the machine-learning-based algorithm is a partially-observable Markov decision process.

Example 9 includes the subject matter of any of Examples 1-8, and wherein to determine the state of the passenger comprises to capture, by a camera of the vehicle, an image of the passenger; analyze the image of the passenger; and determine the state of the passenger based on the analysis of the image of the passenger, and wherein to determine the plurality of natural language generation parameters based on the state of the passenger comprises to determine the plurality of natural language generation parameters based on the analysis of the image of the passenger.

Example 10 includes a method for personalized natural language generation in a vehicle, the method comprising initiating, by a compute device of the vehicle, a dialogue manager; receiving, by the compute device in the vehicle, speech data from a passenger of the vehicle; determining, by the compute device, a state of the passenger; determining, by the compute device, a state of the dialogue manager; performing, by the compute device and in response to receipt of the speech data, an action based on the state of the dialogue manager; determining, by the compute device, a plurality of natural language generation parameters based on the state of the passenger; generating, by the compute device and based on the plurality of natural language generation parameters, a natural language response indicative of the action performed in response to receipt of the speech data; and providing, by the compute device, the natural language response to the passenger.

Example 11 includes the subject matter of Example 10, and wherein determining the state of the passenger comprises analyzing, by the compute device, the speech data of the passenger; and determining, by the compute device, the state of the passenger based on the analysis of the speech data, and wherein determining the plurality of natural language generation parameters based on the state of the passenger comprises determining the plurality of natural language generation parameters based on the analysis of the speech data.

Example 12 includes the subject matter of any of Examples 10 and 11, and further including determining, by the compute device, a state of the vehicle, wherein determining the plurality of natural language generation parameters based on the state of the passenger comprises determining the plurality of natural language generation parameters based on the state of the passenger and based on the state of the vehicle.

Example 13 includes the subject matter of any of Examples 10-12, and wherein determining the plurality of natural language generation parameters based on the state of the passenger and based on the state of the vehicle comprises determining the plurality of natural language generation parameters based on the state of the passenger, the state of the vehicle, and the state of the dialogue manager.

Example 14 includes the subject matter of any of Examples 10-13, and wherein determining the plurality of natural language generation parameters comprises determining one or more prosodic parameters and one or more linguistic parameters.

Example 15 includes the subject matter of any of Examples 10-14, and wherein determining one or more prosodic parameters and one or more linguistic parameters comprises determining, by the compute device, a prosodic parameter indicative of a tempo, a pitch, or a volume; and determining, by the compute device, a linguistic parameter indicative of a register, a lexicon, or a verbosity.

Example 16 includes the subject matter of any of Examples 10-15, and wherein determining the plurality of natural language generation parameters comprises determining the plurality of natural language generation with use of a machine-learning-based algorithm.

Example 17 includes the subject matter of any of Examples 10-16, and wherein determining the state of the passenger comprises capturing, by a camera of the vehicle, an image of the passenger; analyzing, by the compute device, the image of the passenger; and determining, by the compute device, the state of the passenger based on the analysis of the image of the passenger, and wherein determining the plurality of natural language generation parameters based on the state of the passenger comprises determining the plurality of natural language generation parameters based on the analysis of the image of the passenger.

Example 18 includes one or more computer-readable media comprising a plurality of instructions stored thereon that, when executed, causes a compute device of a vehicle to initiate a dialogue manager; receive speech data from a passenger of the vehicle; determine a state of the passenger; determine a state of the dialogue manager; perform, in response to receipt of the speech data, an action based on the state of the dialogue manager, determine a plurality of natural language generation parameters based on the state of the passenger; generate, based on the plurality of natural language generation parameters, a natural language response indicative of the action performed in response to receipt of the speech data; and provide the natural language response to the passenger.

Example 19 includes the subject matter of Example 18, and wherein to determine the state of the passenger comprises to analyze the speech data of the passenger; and determine the state of the passenger based on the analysis of the speech data, and wherein to determine the plurality of natural language generation parameters based on the state of the passenger comprises to determine the plurality of natural language generation parameters based on the analysis of the speech data.

Example 20 includes the subject matter of any of Examples 18 and 19, and wherein the plurality of instructions further causes the compute device to determine a state of the vehicle, wherein to determine the plurality of natural language generation parameters based on the state of the passenger comprises to determine the plurality of natural language generation parameters based on the state of the passenger and based on the state of the vehicle.

Example 21 includes the subject matter of any of Examples 18-20, and wherein to determine the plurality of natural language generation parameters based on the state of the passenger and based on the state of the vehicle comprises to determine the plurality of natural language generation parameters based on the state of the passenger, the state of the vehicle, and the state of the dialogue manager.

Example 22 includes the subject matter of any of Examples 18-21, and wherein to determine the plurality of natural language generation parameters comprises to determine one or more prosodic parameters and one or more linguistic parameters.

Example 23 includes the subject matter of any of Examples 18-22, and wherein to determine one or more prosodic parameters and one or more linguistic parameters comprises to determine a prosodic parameter indicative of a tempo, a pitch, or a volume; and determine a linguistic parameter indicative of a register, a lexicon, or a verbosity.

Example 24 includes the subject matter of any of Examples 18-23, and wherein to determine the plurality of natural language generation parameters comprises to determine the plurality of natural language generation with use of a machine-learning-based algorithm.

Example 25 includes the subject matter of any of Examples 18-24, and wherein to determine the state of the passenger comprises to capture, by a camera of the vehicle, an image of the passenger; analyze the image of the passenger; and determine the state of the passenger based on the analysis of the image of the passenger, and wherein to determine the plurality of natural language generation parameters based on the state of the passenger comprises to determine the plurality of natural language generation parameters based on the analysis of the image of the passenger.

1. A compute device for personalized natural language generation in a vehicle, the compute device comprising:
passenger interface circuitry to:
initiate a dialogue manager;
receive speech data from a passenger of the vehicle;
determine a state of the passenger; and
determine a state of the dialogue manager; and
vehicle interface circuitry to perform, in response to receipt of the speech data, an action based on the state of the dialogue manager,
wherein the passenger interface circuitry is further to:
determine a plurality of natural language generation parameters based on the state of the passenger;
generate, based on the plurality of natural language generation parameters, a natural language response indicative of the action performed in response to receipt of the speech data; and
provide the natural language response to the passenger.

2. The compute device of claim 1, wherein to determine the state of the passenger comprises to:
analyze the speech data of the passenger; and
determine the state of the passenger based on the analysis of the speech data, and
wherein to determine the plurality of natural language generation parameters based on the state of the passenger comprises to determine the plurality of natural language generation parameters based on the analysis of the speech data.

3. The compute device of claim 1, wherein the vehicle interface circuitry is further to determine a state of the vehicle, wherein to determine the plurality of natural language generation parameters based on the state of the passenger comprises to determine the plurality of natural language generation parameters based on the state of the passenger and based on the state of the vehicle.

4. The compute device of claim 3, wherein to determine the plurality of natural language generation parameters based on the state of the passenger and based on the state of the vehicle comprises to determine the plurality of natural language generation parameters based on the state of the passenger, the state of the vehicle, and the state of the dialogue manager.

5. The compute device of claim 1, wherein to determine the plurality of natural language generation parameters comprises to determine one or more prosodic parameters and one or more linguistic parameters.

6. The compute device of claim 5, wherein to determine one or more prosodic parameters and one or more linguistic parameters comprises to:
determine a prosodic parameter indicative of a tempo, a pitch, or a volume; and
determine a linguistic parameter indicative of a register, a lexicon, or a verbosity.

7. The compute device of claim 1, wherein to determine the plurality of natural language generation parameters comprises to determine the plurality of natural language generation with use of a machine-learning-based algorithm.

8. The compute device of claim 7, wherein the machine-learning-based algorithm is a partially-observable Markov decision process.

9. The compute device of claim 1, wherein to determine the state of the passenger comprises to:
capture, by a camera of the vehicle, an image of the passenger;
analyze the image of the passenger; and
determine the state of the passenger based on the analysis of the image of the passenger, and
wherein to determine the plurality of natural language generation parameters based on the state of the passenger comprises to determine the plurality of natural language generation parameters based on the analysis of the image of the passenger.

10. A method for personalized natural language generation in a vehicle, the method comprising:
initiating, by a compute device of the vehicle, a dialogue manager;
receiving, by the compute device in the vehicle, speech data from a passenger of the vehicle;
determining, by the compute device, a state of the passenger;
determining, by the compute device, a state of the dialogue manager;
performing, by the compute device and in response to receipt of the speech data, an action based on the state of the dialogue manager;
determining, by the compute device, a plurality of natural language generation parameters based on the state of the passenger;
generating, by the compute device and based on the plurality of natural language generation parameters, a natural language response indicative of the action performed in response to receipt of the speech data; and
providing, by the compute device, the natural language response to the passenger.

11. The method of claim 10, wherein determining the state of the passenger comprises:
analyzing, by the compute device, the speech data of the passenger; and
determining, by the compute device, the state of the passenger based on the analysis of the speech data, and
wherein determining the plurality of natural language generation parameters based on the state of the passenger comprises determining the plurality of natural language generation parameters based on the analysis of the speech data.

12. The method of claim 10, further comprising determining, by the compute device, a state of the vehicle, wherein determining the plurality of natural language generation parameters based on the state of the passenger comprises determining the plurality of natural language generation parameters based on the state of the passenger and based on the state of the vehicle.

13. The method of claim 12, wherein determining the plurality of natural language generation parameters based on the state of the passenger and based on the state of the vehicle comprises determining the plurality of natural language generation parameters based on the state of the passenger, the state of the vehicle, and the state of the dialogue manager.

14. The method of claim 10, wherein determining the plurality of natural language generation parameters comprises determining one or more prosodic parameters and one or more linguistic parameters.

15. The method of claim 14, wherein determining one or more prosodic parameters and one or more linguistic parameters comprises:
determining, by the compute device, a prosodic parameter indicative of a tempo, a pitch, or a volume; and
determining, by the compute device, a linguistic parameter indicative of a register, a lexicon, or a verbosity.

16. The method of claim 10, wherein determining the plurality of natural language generation parameters comprises determining the plurality of natural language generation with use of a machine-learning-based algorithm.

17. The method of claim 10, wherein determining the state of the passenger comprises:
capturing, by a camera of the vehicle, an image of the passenger;
analyzing, by the compute device, the image of the passenger; and
determining, by the compute device, the state of the passenger based on the analysis of the image of the passenger, and
wherein determining the plurality of natural language generation parameters based on the state of the passenger comprises determining the plurality of natural language generation parameters based on the analysis of the image of the passenger.

18. One or more computer-readable media comprising a plurality of instructions stored thereon that, when executed, causes a compute device of a vehicle to:
initiate a dialogue manager;
receive speech data from a passenger of the vehicle;
determine a state of the passenger;
determine a state of the dialogue manager;
perform, in response to receipt of the speech data, an action based on the state of the dialogue manager,
determine a plurality of natural language generation parameters based on the state of the passenger;
generate, based on the plurality of natural language generation parameters, a natural language response indicative of the action performed in response to receipt of the speech data; and
provide the natural language response to the passenger.

19. The one or more computer-readable media of claim 18, wherein to determine the state of the passenger comprises to:
analyze the speech data of the passenger; and
determine the state of the passenger based on the analysis of the speech data, and
wherein to determine the plurality of natural language generation parameters based on the state of the passenger comprises to determine the plurality of natural language generation parameters based on the analysis of the speech data.

20. The one or more computer-readable media of claim 18, wherein the plurality of instructions further causes the compute device to determine a state of the vehicle, wherein to determine the plurality of natural language generation parameters based on the state of the passenger comprises to determine the plurality of natural language generation parameters based on the state of the passenger and based on the state of the vehicle.

21. The one or more computer-readable media of claim 20, wherein to determine the plurality of natural language generation parameters based on the state of the passenger and based on the state of the vehicle comprises to determine the plurality of natural language generation parameters based on the state of the passenger, the state of the vehicle, and the state of the dialogue manager.

22. The one or more computer-readable media of claim 18, wherein to determine the plurality of natural language generation parameters comprises to determine one or more prosodic parameters and one or more linguistic parameters.

23. The one or more computer-readable media of claim 22, wherein to determine one or more prosodic parameters and one or more linguistic parameters comprises to:
determine a prosodic parameter indicative of a tempo, a pitch, or a volume; and
determine a linguistic parameter indicative of a register, a lexicon, or a verbosity.

24. The one or more computer-readable media of claim 18, wherein to determine the plurality of natural language generation parameters comprises to determine the plurality of natural language generation with use of a machine-learning-based algorithm.

25. The one or more computer-readable media of claim 18, wherein to determine the state of the passenger comprises to:
capture, by a camera of the vehicle, an image of the passenger;
analyze the image of the passenger; and
determine the state of the passenger based on the analysis of the image of the passenger, and
wherein to determine the plurality of natural language generation parameters based on the state of the passenger comprises to determine the plurality of natural language generation parameters based on the analysis of the image of the passenger.
